(19) United States
(12) Patent Application Publication
(10) Pub. No.: US 2019/0090669 A1
(43) Pub. Date: Mar. 28, 2019

(54) FEEDING AID AND METHOD OF USE

(71) Applicant: MASHBLOX PTY LTD, Deakin ACT (AU)

(72) Inventor: Alix O'HARA, Hornsby, New South Wales (AU)

(73) Assignee: MASHBLOX PTY LTD, Deakin ACT (AU)

(21) Appl. No.: 16/087,031

(22) PCT Filed: Mar. 22, 2017
(86) PCT No.: PCT/AU2017/050257

§ 371 Date: Sep. 20, 2018

(30) Foreign Application Priority Data
Mar. 23, 2016 (AU) 2016901093
Aug. 2, 2016 (AU) 2016903045
Oct. 31, 2016 (AU) 201625346

(51) Int. Cl. A47G 21/00; B65D 1/32; B65D 25/56; B65D 47/20; B65D 85/72; A61J 9/00

(52) U.S. Cl. CPC A47G 21/001; B65D 1/32; A61J 9/005; B65D 47/2031; B65D 85/72; B65D 25/56

(57) ABSTRACT

A feeding aid for promoting use of hands to eat, comprising: a hollow receptacle formed of a non-toxic and food safe material that is at least partially deformable and adapted to store food and/or frozen liquid consumables; an access portion that is partially open when the receptacle is in an undeformed state and which, in response to the receptacle being deformed by a user, is configured to open further to thereby allow access to the stored consumables, and to assist in turning the receptacle at least partially inside out for cleaning.

### FIELD OF INVENTION

The present invention relates to a feeding aid and corresponding method of use.

### BACKGROUND OF INVENTION

There are numerous techniques parents employ to teach a child how to feed themselves. For instance, one commonly employed technique is to hold small pieces of food out for a young child and thereafter release the food once the child has gripped the food using their thumb and index finger (commonly referred to as the “pincer grip”). Although this method can be useful in encouraging eating (and dexterity), it requires a great deal of time, attention and patience. Further, many foods do not lend themselves to be portioned, presented and/or grasped in this manner.

Another commonly used technique is to place food onto colourful and entertaining plates, for example that are shaped like animals or have interesting designs that can only be seen once the child eats their food. Such plates are used to entertain and therefore incentivise the child to eat the food on the plate. However, placing food on a plate can result in very messy eating and requires that the child stay seated while eating the food to prevent spillage. In addition, fussy eaters may decide not to eat the food if they do not like the way it looks on the plate.

Another convenient method of feeding infants is for parents to provide a pouch and spout package of baby food, which the child can consume themselves. However, the narrow opening of the spout requires that the food is a fine puree, which is typically sweetened (usually with fruit) to be palatable to the child, and also packaged in portions in excess of an infant's nutritional needs. Further, an over reliance on puree food both encourages mindless calorie consumption, and discourages healthy oral physiological development in the child.

It would be beneficial if there was provided a device and corresponding method of use that allowed children to play with their food so as to promote autonomy in feeding themselves, especially with different textured and lumpy foods that don't need to be sweetened to be tasty, while at the same time providing the ability to self-regulate portion size, develop a child's basic problem solving ability and be entertaining for the child.

Malnutrition is a concern for older people living in aged care facilities. This can have many causes, but one reason is that through age-related illness or loss of strength and dexterity, people lose the physical capacity to handle cutlery and crockery, leading to lower food intake. Current solutions include modifications on standard eating implements: thicker handles on cutlery and self-levelling spoons, as well as weighted plates with ergonomic supports for use. Further, eating can be a struggle for others with a disability affecting their motor function, which is often addressed by carers feeding those affected at great expense and loss of independence.

It would be beneficial if there was provided a device requiring less dexterity than conventional techniques, that allowed persons with a physical disability to use their hands to eat.

### SUMMARY OF INVENTION

In accordance with a first aspect there is providing a feeding aid for promoting use of hands to eat, comprising: a hollow receptacle formed of a non-toxic and food safe material that is at least partially deformable and adapted to store food and/or frozen liquid consumables; an access portion that is partially open when the receptacle is in an undeformed state and which, in response to the receptacle being deformed by the user, is configured to open further to thereby allow access to the stored consumables.

In an embodiment the receptacle is biased in the undeformed state.

In an embodiment the feeding aid according to any one of the preceding claims, wherein the food can be procured from the receptacle in the deformed state by retrieving the food through the access portion.

In an embodiment the receptacle has multiple side walls and wherein the access portion comprises an elongate slit at least partially extending across one or more of the side walls.

In an embodiment the multiple walls are joined so as to form a three-dimensional primary shape.

In an embodiment the receptacle takes the form of a rounded shape and wherein the access portion comprises an elongate slit at least partially extending across a circumferential wall.

In an embodiment the material is a dishwasher and microwave safe material.

In an embodiment the receptacle is at least mostly composed of an elastomeric material.

In an embodiment the elastomeric material is a silicon rubber.

In an embodiment the receptacle is labelled so as to provide an indication of the amount of food stored in the receptacle

In an embodiment the receptacle is deformable to an extent that it allows the receptacle to at least partially be turned inside out for accessing inner walls for cleaning.

In accordance with a second aspect there is provided a method of encouraging consumption of textured and lumpy foods, and controlling hygienic food play and use of hands to eat, comprising: deforming a feeding aid as described in accordance with the first aspect so as to open the access portion for placing food of varying textures and composition into the receptacle; releasing the feeding receptacle so as to allow the feeding aid to return to an undeformed rest state to thereby at least partially enclose the food within the receptacle; and providing the feeding aid to the recipient.

### BRIEF DESCRIPTION OF DRAWINGS

Embodiments of the present invention will now be described, by way of example only, with reference to the accompanying drawings, in which:

FIGS. 1a, 1b and 1c are perspective, top and side views, respectively, of a feeding aid in accordance with a first embodiment of the present invention;

FIGS. 2 and 3 are “in use” views for the feeding aid of FIG. 1;

FIG. 4 shows the feeding aid of FIG. 1 turned inside out for cleaning;

FIGS. 5a, 5b and 5c are perspective, top and side views, respectively, of a feeding aid in accordance with a first embodiment of the present invention; and

FIG. 6 shows various embodiments of a feeding aid incorporating portion control markings.

### DETAILED DESCRIPTION

Embodiments of the invention described herein relate generally to a feeding aid and corresponding method of use for promoting the use of hands for eating. In general terms, the feeding aid comprises a hollow receptacle which is formed of a food safe and at least partially deformable and resilient material, such as a silicon rubber. The receptacle is adapted to contain food and liquid consumables. The receptacle further comprises an access portion that remains partially open when the receptacle is in an un-deformed rest state and which is configured to open further in response to the receptacle being deformed by a user, thereby allowing access to the stored food.

As will become evident from subsequent paragraphs, a feeding aid as described herein can be used for encouraging eating, especially of textured, lumpy, or differently coloured foods or foods that otherwise lack visual appeal; for promoting autonomous eating, for educational purposes, for providing meal-time entertainment and for managing portion control. The feeding aid may allow any one or more of these objectives to be achieved by harnessing a child's natural curiosity, agency and playful nature, whilst at the same time minimising mess. The invention may advantageously draw on a child's basic problem solving ability in finding access to food through the partially open access portion and manipulation of the receptacle to further open the access portion to thereby access the food.

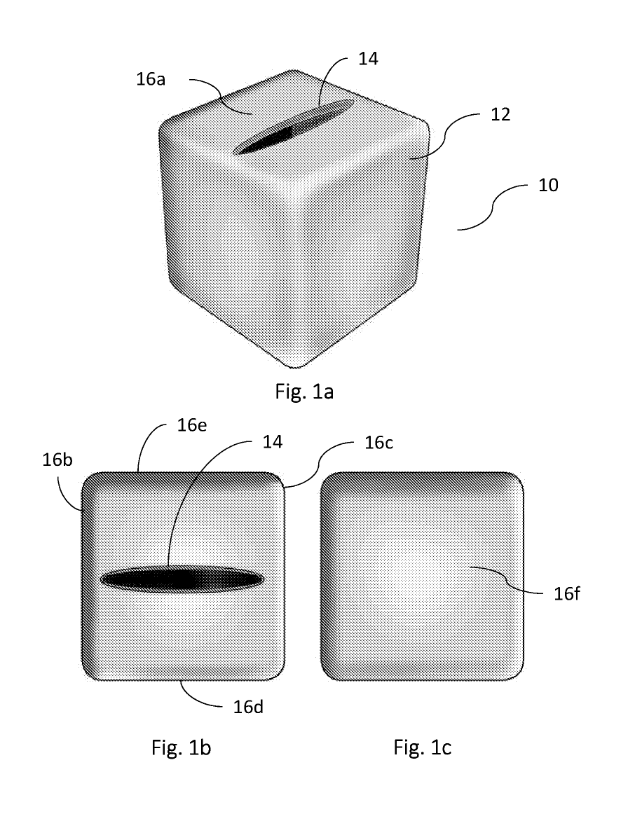

In more detail, and with reference to FIG. 1, there is depicted a first embodiment of the present invention in an un-deformed “at rest” state. Such an embodiment is particularly suited as a feeding aid for use by babies and young children and accordingly will be described in such a context. It will be understood, however, that embodiments are not so limited and could be used by older users for other uses, as will be described toward the end of the description.

According to the embodiment illustrated in FIG. 1, the feeding aid 10 comprises of a hollow receptacle 12 taking the form of a three-dimensional deformable cube. The material has resilient properties which allows the receptacle 12 to return to its non-deformed state when there is no deforming force applied thereto. The receptacle 12 is formed of a food safe elastomer, such as a non-toxic silicon rubber.

The receptacle 12 has an access portion which is shaped in the form of an elongate slit 14 extending at least partially across a side wall 16a of the receptacle 12 (according to the illustrated embodiment, the slit is shaped in the form of an ellipsis and extends substantially the length of the wall 16a). As shown, in the rest state, the slit 14 is both partially open but sufficiently closed to substantially enclose the receptacle 12 and consumables stored therein. In a particular embodiment, at its midpoint, the side walls of the slit are separated by a spacing of between 1 mm to 10 mm. More preferably, the separation is between 3 mm to 8 mm. The function of the slit 14 is to allow food, especially semi-solids or foods of mixed texture or liquid consumables, to be placed in the receptacle; and thereafter removed from the receptacle (e.g. during food play/exploration, or for convenience), and for the receptacle to be turned inside out for cleaning, as will be described in more detail in subsequent paragraphs. By remaining substantially closed in the rest state, the slit 14 may prevent food spillage and mess during use. Such a configuration also serves to maintain food hygiene during use (i.e. by preventing the stored food from coming into contact with surfaces on which the aid 10 is placed, dropped, etc.).

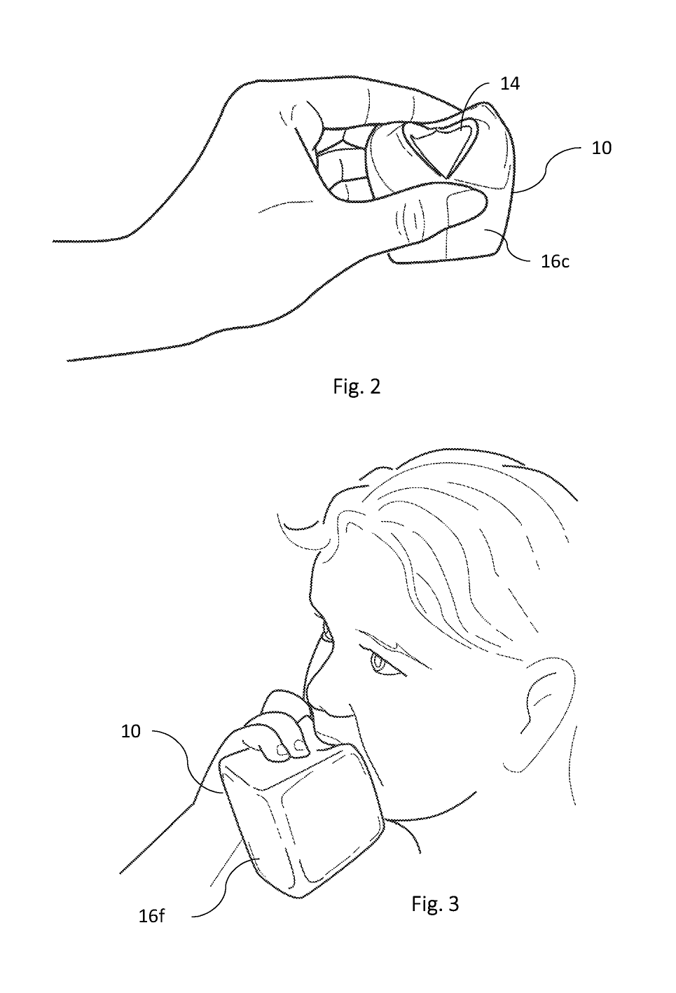

FIG. 2 shows the receptacle 12 in a deformed “in use” state for allowing access to the receptacle via the opening 14 (in this instance by squeezing side walls 16b and 16c together so as to further open the slit 14). It will be understood that the slit 14 may be opened further by deforming the receptacle 12 in various ways, for example by squeezing various combinations of side walls 16a to 16f together, by pressing down on one of the walls 16a to 16f while the receptacle 12 is seated on a surface, by prying the slit 14 open (i.e. deforming wall 16a) including by use of a device such as a wrack for this purpose, or by inserting a finger, tongue, lip, etc. into the receptacle 12 through the slit 14. This is best shown in FIG. 3. The access portion is considered “open” when there is sufficient of an opening to access the food that is stored in the receptacle 12.

A method of using the aid 10, thus involves initially filling the receptacle 12 with a suitable food or liquid to be frozen. This may result in the food moulding to the internal shape of the receptacle 12 depending on its consistency or how it may be prepared once in the receptacle, such as by freezing or baking. Once stored, the aid 10 is then presented to the child. As persons skilled in the art will appreciate, it is a universal tendency for children to attempt to use their hands to eat, and to play with their food. Through such play the child will learn that they can access the stored contents by suitably deforming the receptacle to allow the food to be sucked or squeezed out through the slit 14, or by digging the food out with their fingers, tongue, etc.

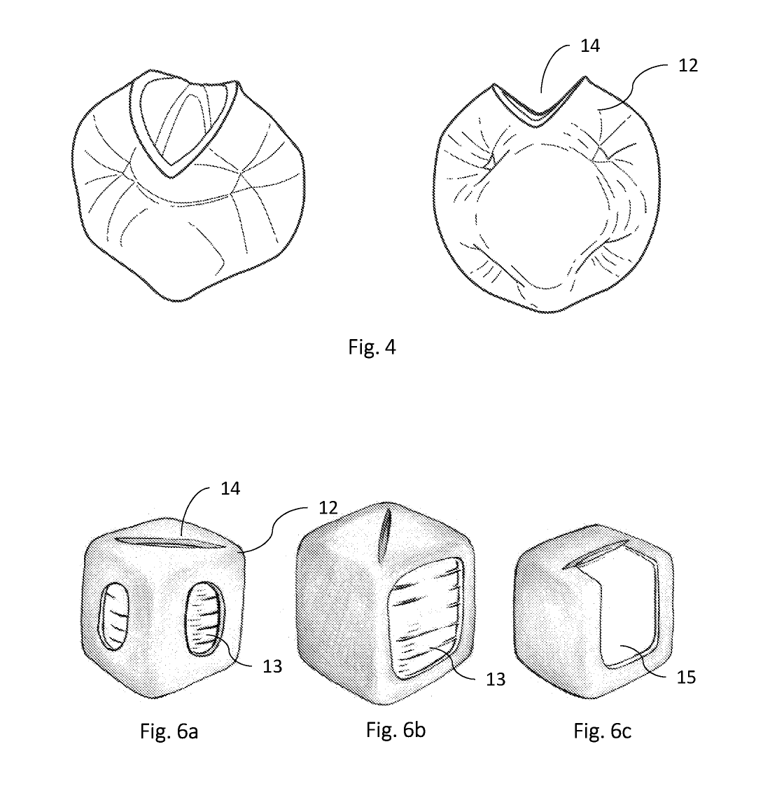

As shown in FIG. 4, the elastomeric material and slit configuration of the feeding aid 10 allow it to be turned inside out after use. This advantageously allows the feeding aid 10 to be easily and thoroughly cleaned ready for the next use.

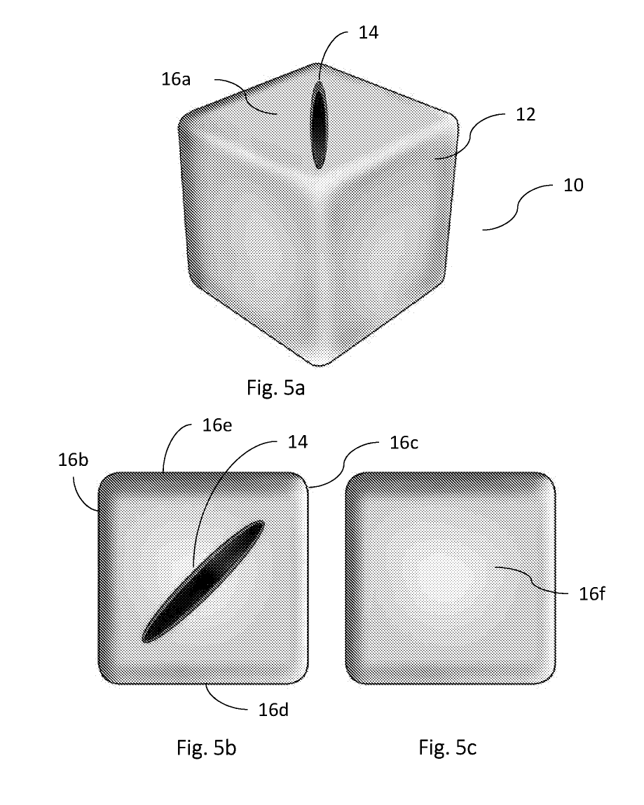

An alternative embodiment of the feeding aid 10 is shown in FIGS. 5a to 5c whereby the elongate slit 14 extends diagonally across the top wall 16a.

The receptacle 12 may be coupled to a handle (e.g. similar to a baby rattle). This allows the receptacle 12 to be readily grasped and may provide a further level of entertainment for the child. It will be appreciated by persons skilled in the art that the shape of the handle may take numerous different forms, including a short or stumpy handle, a hook, a curved handle such as on a mug, a protrusion suited to being gripped by the user, or any suitable shape depending on the desired implementation.

With reference to FIGS. 6a to 6c there are shown various potential configurations of a receptacle 12 including a window 15 either with or without markings 13 disposed thereon for providing a visual indication of the amount of food within the receptacle. These markings may take the form, for example, of volumetric units. Such markings advantageously allow the child's parent or carer to know the portion size of the stored food, aiding in portion control.

Persons skilled in the art will appreciate that the hollow receptacle 12 of the feeding aid can take on numerous different shapes and configurations. For example, the receptacle 12 could be in the form of a fruit such as a strawberry, apple or banana (i.e. with the opening 14 disposed on a suitable location thereon for allowing access to the stored contents). The receptacle 12 could also take the form of different recognisable shapes such as a cylinder, rectangular prism, pyramid, sphere, star, diamond, etc. The receptacle 12 could also take the form of more complex shapes such as a phone, rattle, lolly, mushroom, flower, among others. For example, with regards to a flower embodiment, the receptacle 12 may comprise a central chamber having one or more bulbous projections which extend therefrom and whereby an access portion may be provided on one or more of the bulbous projections (i.e. through which the user can gain access to contents stored in the central chamber and/or projections). Still further, to accelerate a child's understanding and recognition of an eating utensil, the receptacle 12 could be shaped in the form of a spoon, fork, etc. For example, with regards the spoon embodiment, the access portion may be disposed on an edge of the circular feeding portion.

The receptacle 12 may provide one or more indentations on one or more walls/surfaces that allow the receptacle to be stacked on top of another receptacle. In another embodiment, the receptacle 12 may be provided with a coupling means that allows it to be coupled to another receptacle (e.g. via a clip, chain, or other suitable coupling). Such additions may encourage a child to use the aid 10 at school, or even for collecting and trading receptacles (e.g. with other children).

It will also be understood that the colour of the receptacle 12 can vary, depending on the desired implementation. The receptacle may, for example, be multi-coloured, such as for a lady beetle shaped receptacle (e.g. where the lady beetle may be red with black spots). In another embodiment, the receptacle 12 may be translucent so that the contents of the food may be visible to the child. Alternatively, the receptacle may be opaque to increase the surprise or to benefit children with fussy eating habits, that will use a food's visual appearance to excuse themselves from eating it.

The combination of colours and shapes may advantageously encourage shape/colour recognition and may result in the child having a favourite shape/colour. This may be used to encourage children to eat foods that they do not like by placing it in a receptacle of their favourite shape/colour. Feeding aids as described herein may also educate children on different shapes, colours, games, numbers and things, such as for novelty shapes of e.g. a lady beetle. It may also educate them on mathematics and the alphabet (i.e. where the feeding aid is correspondingly shaped or marked with corresponding letters and/or numbers).

According to the embodiment described above, the receptacle 12 was formed of an elastomeric rubber. Examples include non-toxic natural rubber, polyurethanes, polybutadienes, neoprene and silicone. In particular, nitrile, latex, thermoplastic elastomers (TPEs) or silicone are preferred. Persons skilled in the art will appreciate that the receptacle is not limited to being formed by a single elastomer, and may be formed of numerous elastomers, and may have plastic components.

The material used to form the receptacle 12 is preferably dishwasher and microwave safe.

The receptacle is intended to be re-usable, however or particular applications may be configured for “one time” use and then discarded.

According to the above described embodiments, the access portion was in the form of an elongate slit 14 located on a single side wall of the receptacle 12. However, it will be understood that the access portion may take on other forms located on any desired portion of the receptacle. For example, the access portion may take the form of a small round opening located on an edge of the receptacle.

Further, one or more branches may extend from the opening 14 (whether it be elongate, round or otherwise) to further facilitate access to the stored contents. In a particular embodiment, the opening 14 may be reinforced. For example, a reinforcement means may be provided at each end of the slit. As an alternative, the ends of the access portion may be rounded so that they are less likely to tear. In an embodiment, the receptacle is manufactured such that the ends are initially round and open. They are then filled with a softer silicon, so they maintain their protective properties, but don't leak consumables. The access portion may also be sealed e.g. by a lid, seal (e.g. a sticker that can be detachable stuck over the access portion) or plug that sits in the access portion. This lid, seal or plug may or may not be made of different material to the receptacle. In yet another embodiment, a latch may be provided for keeping the access portion closed. The access portion may also have an envelope like structure such that a flap or other means is disposed over the corresponding opening. In yet another embodiment, the internal edge of each side of the portion are adapted to slot together when the device is deformed closed, such as under pressure within a suitably shaped rigid container.

Typical foodstuffs for storing in the food aid 10 include, for example, small or cut up pieces of food, mushy children's food, fruits, jelly, frozen juice, among others. The food aid 10 is also able to accommodate cake mix, raw eggs, etc. that require cooking before eating. In an embodiment of the invention, cold or uncooked food may be placed in the food aid 10 and subsequently heated/cooked in a microwave or oven. The food aid 10 can then be presented to the child (ensuring that the contents are not too hot for the child to eat). In an embodiment, the material from which the receptacle 12 is formed may include a temperature sensitive pigment or other suitable heat indicating device to show when the food is too hot. Further, once the food has been cooked, it can readily be transported in the same receptacle, without the need to transfer the food into a separate container.

Preferably, the receptacle is smooth to provide comfort to a user's mouth and hands, and non-porous so that it is easy to reach the stored food and clean the receptacle after use.

The receptacle can also contain food that melts over time such as ice blocks or jelly, or any liquid. In an embodiment of the invention, the receptacle can be frozen to create an ice block.

The food aid 10 may also be used to assist those with a disability that makes it difficult to eat, including persons that struggle with sensory integration of food. The sensory integration difficulties of autism, for example, can break the eating process into discrete steps; seeing the food, then smelling, then touching, then tasting, then taking a nibble (and maybe spitting it out), then finally swallowing. A feeding aid 10 as described herein reduces the sensory input requirements mostly to touch & taste (and nibble and swallow) which may make the feeding process easier for those with autism. Dementia sufferers can struggle to differentiate food from the rest of their environment. Having a neat package (in the form of the feeding aid) may be easier for persons suffering with dementia, provided they recognise it as holding food.

In addition, individuals who have motor function difficulties and struggle to raise a fork or spoon (e.g. people with Parkinsons, cerebral palsy, ataxia, muscle wastage, or even arthritis) may be able to use the receptacle as an easier means of consuming food with little to no spillage.

At least one of the following advantages arise from a feeding aid having a deformable body with a partially open access portion according to one or more embodiments as described herein:
The partially open access portion allows users, especially small children or older users with a visual impairment, to see where and how they can gain access to stored consumables;
The partially open access portion allows for easy access to stored consumables using tongue or fingers;
The partially open access portion allows for consumables to be easily placed within the receptacle;
The partially open access portion allows users to smell the contents which may promote appetite and investigation;
The configuration of the access portion allows the receptacle to be readily turned inside out for cleaning;
The configuration of the access portion allows for storage of foods of varying size and texture. The present inventor has found that a deformable receptacle with such a configured access portion surprisingly makes the receptacle suitable for use as more than merely a container and specifically as a feeding aid which results in the various benefits described in preceding paragraphs. For example, it has been found that a receptacle as described herein is particularly beneficial for encouraging infants to self feed (without making a great deal of mess), as well as allowing them to control their food intake and maintain their instincts when they are full; and
Due to the slit allowing for insertion and extraction of different textured foods, it also promotes a healthier range of foods than sweetened purees. This has obvious dietary benefits, but may also benefit speech pathology in infants;
A feeding aid as described herein operates to largely conceal the food and thus children do not have the excuse of not liking a food before they have had the opportunity to taste it.

Persons skilled in the art will appreciate that the receptacle can be used for other purposes than for a feeding aid, such as being used as a storage container, a coin purse or a holder to store small items such as buttons.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive.

Furthermore, the inventions have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A feeding aid for promoting use of hands to eat, comprising:
a hollow receptacle formed of a non-toxic and food safe material that is at least partially deformable and adapted to store a consumable, the stored consumable comprising food, liquid, or both food and liquid;
an access portion that is partially open when the receptacle is in an undeformed state and which, in response to the receptacle being deformed by a user, is configured to open further to thereby allow access to the stored consumable.

2. The feeding aid of claim 1, wherein the receptacle is biased in the undeformed state.

3. The feeding according to claim 1, wherein the stored consumable can be procured from the receptacle in the deformed state by retrieving the stored consumable through the access portion.

4. The feeding aid according to claim 1, wherein the receptacle has multiple side walls and wherein the access portion comprises an elongate slit at least partially extending across one or more of the side walls.

5. The feeding aid according to claim 4, wherein the multiple side walls are joined to form a three-dimensional primary shape.

6. The feeding aid according to claim 1, wherein the receptacle takes the form of a rounded shape and wherein the access portion comprises an elongate slit at least partially extending across a circumferential wall.

7. The feeding aid according to claim 1, wherein the material is a dishwasher and microwave safe material.

8. The feeding aid according to claim 7, wherein the material comprises an elastomeric material.

9. The feeding aid according to claim 8, wherein the elastomeric material comprises a silicon rubber.

10. The feeding aid according to claim 1, wherein the receptacle is labelled so as to provide an indication of the amount of the consumable stored within the receptacle.

11. The feeding aid according to claim 1, wherein the receptacle is deformable to an extent that it allows the hollow receptacle to at least partially be turned inside out through the access portion for accessing one or more inner walls for cleaning.

12. A method of encouraging and controlling hygienic food play or eating with hands, comprising:
deforming a feeding aid as claimed in claim 1 so as to sufficiently open the access portion for placing the consumable into the receptacle;
releasing the feeding receptacle so as to allow the feeding aid to return to the undeformed state to thereby at least partially enclose the consumable within the receptacle; and
providing the feeding aid to a recipient.
